(19) United States
(12) Patent Application Publication
(10) Pub. No.: US 2009/0079926 A1
(43) Pub. Date: Mar. 26, 2009

(54) Circuit structure of liquid crystal display module and assembly method thereof

(75) Inventors: Xian-Zhen GAO, Suzhou Industrial Park (CN); Shuang HOU, Suzhou Industrial Park (CN); Cheng-Wei YANG, Suzhou Industrial Park (CN)

Correspondence Address: RABIN & Berdo, PC, 1101 14TH STREET, NW, SUITE 500, WASHINGTON, DC, 20005, US

(73) Assignees: AU Optronics (Suzhou) Corp., Ltd., Suzhou Industrial Park (CN); AU OPTRONICS CORP., Hsin-Chu (TW)

(21) Appl. No.: 12/078,914

(22) Filed: Apr. 8, 2008

(30) Foreign Application Priority Data
Sep. 20, 2007 (CN) 200710153479.2

(51) Int. Cl. G02F 1/133; G02F 1/1343

(52) U.S. Cl. 349/150; 349/149; 349/151; 445/24

(57) ABSTRACT

A protective circuit structure of a liquid crystal display is described. The protective circuit structure includes a display panel substrate with a plurality of circuit layers and a bonding area. A plurality of holes are disposed in the bonding area to connect to the circuit layers. A driving circuit is adhered to the bonding area to cover the holes. In addition, an assembly method of a liquid crystal display module is also disclosed herein.

### RELATED APPLICATIONS

This application claims priority to China Patent Application Serial Number 200710153479.2, filed Sep. 20, 2007, which is herein incorporated by reference in its entirety.

### FIELD OF THE INVENTION

The present invention generally relates to a circuit structure and an assembly method for a liquid crystal display. More particularly, this invention relates to a protective circuit structure and an assembly method for a liquid crystal display to prevent damage to the electronic circuit of the liquid crystal display.

### BACKGROUND OF THE INVENTION

Electronic products are gradually becoming smaller and lighter. The electronics bonding technology is therefore rapidly developing to satisfy the various manufacturing requirements of the newer and smaller electronic products. The bonding technologies for manufacturing the liquid crystal display (LCD) at least include, for example, tape automated bonding (TAB), chip on glass (COG) or chip on film (COF).

However, in the process of manufacturing display panels, a plurality of through holes are formed to electrically connect various circuit layers therein. To prevent any influence from the surrounding environment on the circuit layers through the holes, protective glue has to be used to cover the holes after a driving circuit is bonded to the display panel substrate. Nonetheless, the terminals of the display panel substrate may therefore be burned due to the high operating temperature of the protective glue. Therefore, some of the display panels are no longer serviceable or have to be repaired so as to increase the manufacturing cost of the liquid crystal display.

FIG. 1A illustrates a conventional chip on glass (COG) bonding technology to attach an integrated circuit to a display panel substrate. FIG. 1B illustrates a conventional chip on film (COF) bonding technology to attach a circuit board to a display panel substrate. Referring to FIG. 1A, a TFT substrate 160 includes a plurality of substrate terminals 120 and a plurality of through holes 130. The holes 130 are covered by a protective glue 140 to prevent influence of surrounding environment on the circuits thereof. The substrate terminals 120 are electrically connected to metal bumps 150 of an integrated circuit 110 of a driving circuit. In addition, the holes 130 and the integrated circuit 110 are disposed on the outside of the color filter (CF) substrate 170 of a liquid crystal display, that is to say, the holes 130 and the integrated circuit 110 are disposed on a non-display area of the liquid crystal display.

Referring to FIG. 1B, a TFT substrate 260 includes a plurality of substrate terminals 220 and a plurality of through holes 230. Protective glue 240 covers the holes 230. A circuit board 210 of a driving circuit is bonded to the TFT substrate 260 to electrically connect circuit board conductive terminals 250 to substrate terminals 220 through an anisotropic conductive film 280. Furthermore, the holes 230 and the circuit board 210 of the driving circuit are also disposed on the outside of the CF substrate 270, i.e. a non-display area of the liquid crystal display.

Referring to FIG. 4, there is shown an assembly flowchart of a conventional liquid crystal display module. In step 510, a display panel substrate with a plurality of holes for assembling a flat panel display is provided. Subsequently, an adhesive layer is adhered thereon in step 520. A driving circuit is then bonded to the display panel substrate in step 530. Protective glue is dispensed on the holes to protect the electronic circuits therein from the surrounding environment in step 540. The display panel substrate is combined with a backlight module to form a flat panel display module in step 550.

Accordingly, holes that electrically connect a plurality of circuit layers are covered by protective glue to prevent the circuit layers from being damaged by the surrounding environment. However, the protective glue is dispensed on the display panel substrate with a high operating temperature so as to easily damage the terminals on the display panel substrate. Therefore, the manufacturing cost of the liquid crystal display is increased due to a large number of scraps and rework for the liquid crystal display.

### SUMMARY OF THE INVENTION

One objective of the present invention is to provide a protective circuit structure of a liquid crystal display to protect the electronic circuits of the liquid crystal display without dispensing high temperature glue on the holes on a TFT substrate of the liquid crystal display.

Another objective of the present invention is to provide an assembly method of a liquid crystal display to protect the electronic circuits of the liquid crystal display without dispensing high temperature glue on the holes on a TFT substrate of the liquid crystal display.

To achieve these and other advantages and in accordance with the objective of the present invention, as the embodiment broadly describes herein, the present invention provides a circuit structure of a liquid crystal display including a display panel substrate having a plurality of circuit layers and a bonding area. A plurality of holes are disposed at the bonding area to electrically connect a plurality of circuit layers of the display panel substrate. While the driving circuit is attached to the bonding area, the driving circuit covers the holes.

The driving circuit is preferably a chip on film circuit board or a tape automated bonding circuit board. In a preferred embodiment, an adhesive layer, for example, an anisotropic conductive film, is disposed between the driving circuit and the bonding area to electrically connect the driving circuit to the display panel substrate.

Another aspect of the present invention is to provide an assembly method of a liquid crystal display. A display panel substrate is first provided and includes a plurality of circuit layers, a bonding area and a plurality of holes. The holes are disposed at the bonding area to electrically connect the circuit layers in the display panel substrate. An adhesive layer is adhered to the bonding area of the display panel substrate and covers the openings. In addition, a driving circuit is attached to the bonding area of the display panel substrate under a predetermined temperature and a predetermined pressure and the driving circuit also covers the holes. Furthermore, the display panel substrate is combined with a backlight module to form a flat panel display module.

Hence, the holes for electrically connecting the circuit layers in the display panel substrate according to the present invention are shifted to the bonding area under the driving circuit so that the driving circuit and the adhesive layer for connecting the driving circuit to the bonding area can effectively protect the holes and the circuit layers of the display panel substrate from being damaged by the surrounding environment. Furthermore, the holes shifted to the bonding area can also prevent the terminals of the display panel substrate from being burned by the high temperature protective glue because the protective glue is no longer used. Therefore, the assembly method of a liquid crystal display module according to the present invention can effectively simplify the manufacture process and further reduce the manufacture cost thereof.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1A illustrates a conventional chip on glass (COG) bonding technology to attach an integrated circuit to a display panel substrate;

FIG. 1B illustrates a conventional chip on film (COF) bonding technology to attach a circuit board to a display panel substrate;

FIG. 2 illustrates a preferred embodiment of the protective circuit structure according to the present invention;

FIG. 3 illustrates another preferred embodiment of the protective circuit structure according to the present invention;

FIG. 4 is an assembly flowchart of a conventional flat panel display module; and

FIG. 5 is an assembly flowchart of the flat panel display module according to the present invention.

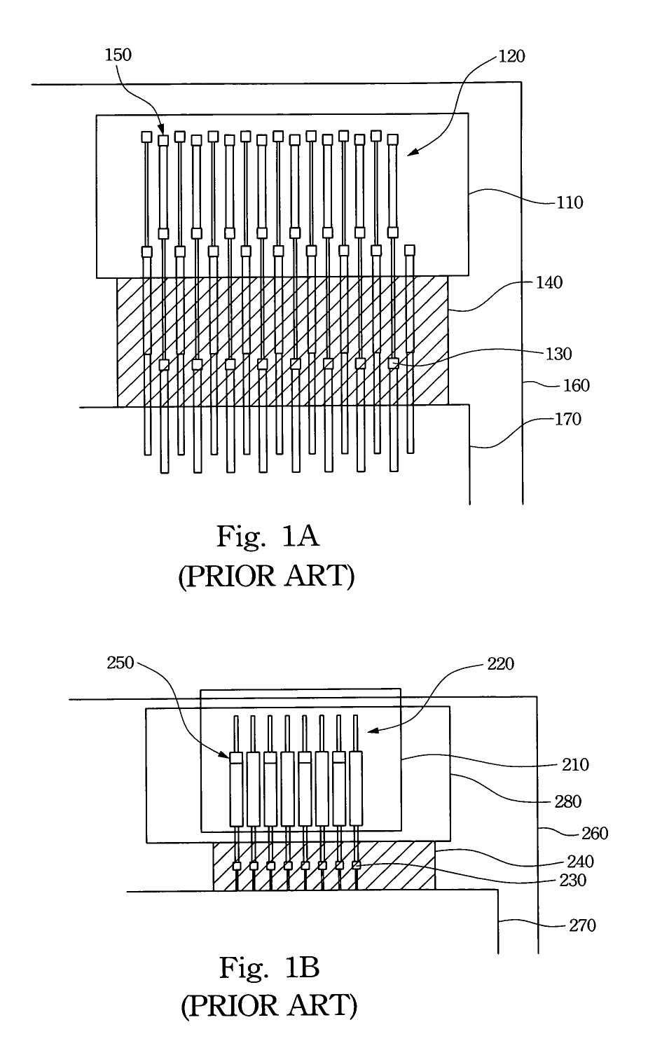

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

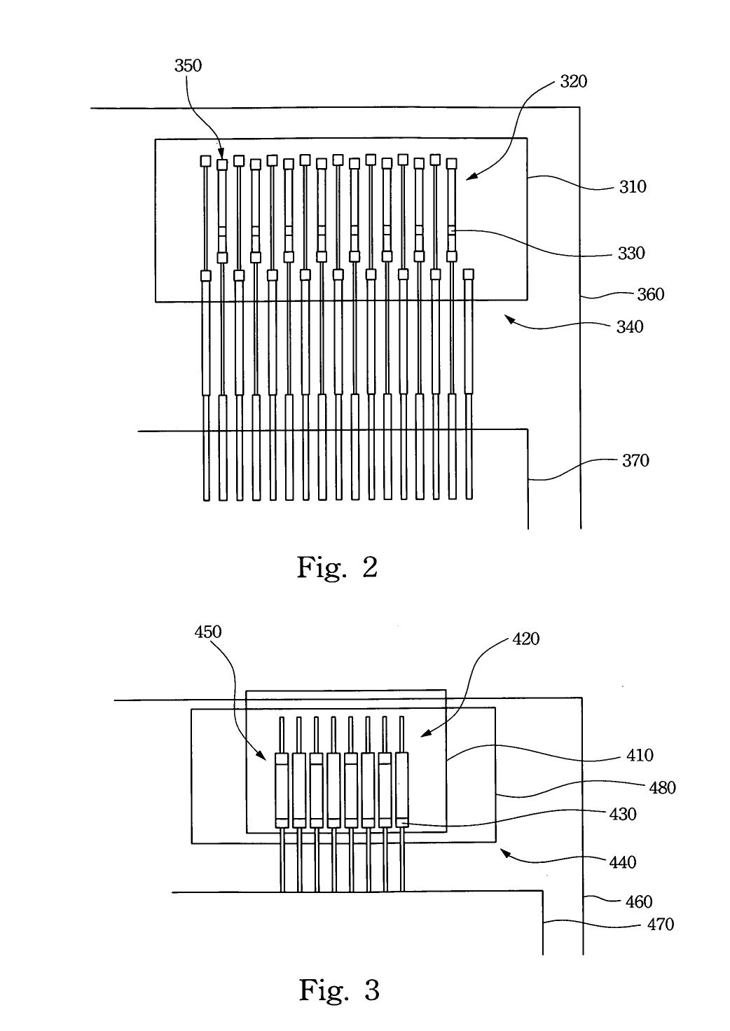

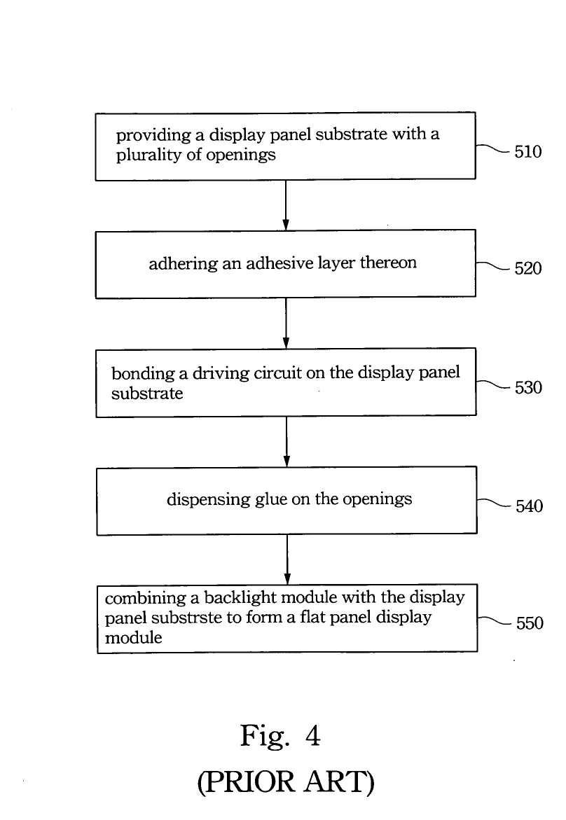

FIG. 2 illustrates a preferred embodiment of the protective circuit structure according to the present invention. In this preferred embodiment, chip on glass bonding technology adheres the integrated circuit to the display panel substrate. The TFT substrate 360 with circuit layers includes a plurality of substrate terminals 320 and a plurality of holes 330. An integrated circuit 310 is attached to a bonding area of the TFT substrate 360. The substrate terminals 320 are electrically connected to metal bumps 350 ofthe integrated circuit 310. The holes 330 are electrically connected to the circuit layers of the TFT substrate 360. The holes 330 are disposed on the area of the TFT substrate 360 where the integrated circuit 310 is attached thereon. Therefore, the holes 330 are preferably disposed at the bonding area and under the integrated circuit 310. After the adhesive layer 340 attaches the integrated circuit 310 to the bonding area, the adhesive layer 340 and the integrated circuit 310 can effectively protect the holes 330 so as to prevent the circuit layers from being damaged by the surrounding environment. The adhesive layer 340 is a non-liquid tape and can effectively adhere the integrated circuit 310 to the TFT substrate 360. In a preferred embodiment, the integrated circuit 310 is electrically connected to the substrate terminals 350 by the anisotropic conductive film. The holes 330 and the integrated circuit 310 are both disposed on the outside of the CF substrate 370, also referred to as the non-display area of the liquid crystal display.

FIG. 3 illustrates another preferred embodiment of the protective circuit structure according to the present invention. The TFT substrate 460 with a plurality of circuit layers includes a plurality of substrate terminals 420 and a plurality of holes 430. A driving circuit board 410 is attached to a bonding area of the TFT substrate 460. The holes 430 electrically connect a plurality of circuit layers of the TFT substrate 460. The holes 430 are disposed at an area where the driving circuit board 410 is connected to the TFT substrate 460. That is to say, the holes 430 are disposed on the bonding area under the driving circuit board 410. Therefore, after an adhesive layer 440 attaches the driving circuit board 410 to the bonding area of the TFT substrate 460, the adhesive layer 440 and the driving circuit board 410 can effectively protect the holes 430 so as to prevent the circuit layers from being damaged by the surrounding environment. In a preferred embodiment, the adhesive layer 440 is an anisotropic conductive film 480 to fix and electrically connect the circuit board conductive terminals 450 to the substrate terminals 420. In addition, the holes 430 and the driving circuit board 410 are both disposed on the outside of the CF substrate 470, also referred to as the non-display area of the liquid crystal display.

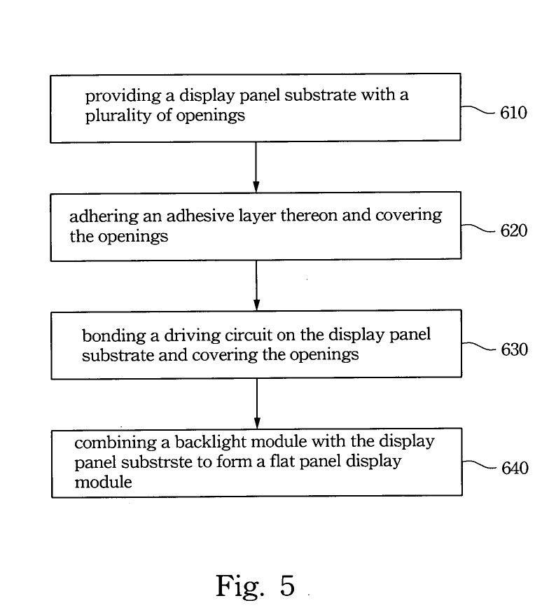

Referring to FIG. 5, there is shown an assembly flowchart of the liquid crystal display module according to the present invention. In step 610, a display panel substrate with a plurality of circuit layers and a plurality of holes is provided. In step 620, an adhesive layer is adhered to the display panel substrate and covers the holes. In step 630, a driving circuit is then adhered to the display panel substrate. Since the holes are disposed under the circuit board of the driving circuit, the adhesive layer and the circuit board protect the holes to prevent the holes and the circuit layers from being damaged by the surrounding environment. In step 650, the display panel substrate is combined with a backlight module to form a flat panel display module. Hence, the assembly method of the liquid crystal display module according to the present invention can effectively protect the plurality of holes and the circuit layers without the step of dispensing protective glue on the holes.

Accordingly, the circuit structure and the assembly method for a liquid crystal display module according to the present invention can protect the holes and the circuit layers in the display panel substrate with the adhesive layer and the driving circuit attached thereon while the holes are shifted to the bonding area under the driving circuit. Therefore, the circuit structure and the assembly method for a liquid crystal display according to the present invention can effectively simplify the manufacture process and further reduce the manufacture cost.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A circuit structure for use in a liquid crystal display, comprising:
a display panel substrate having a plurality of circuit layers and a bonding area;
a driving circuit attached to the bonding area; and
a plurality of holes formed at the bonding area to electrically connect the circuit layers of the display panel substrate, wherein the driving circuit covers the holes.

2. The circuit structure of claim 1, wherein the driving circuit comprises an integrated circuit for driving the liquid crystal display.

3. The circuit structure of claim 1, wherein the driving circuit comprises a chip on film circuit board.

4. The circuit structure of claim 1, wherein the driving circuit comprises a tape automated bonding circuit board.

5. The circuit structure of claim 1, further comprising an adhesive layer disposed between the driving circuit and the bonding area to electrically connect the driving circuit to the display panel substrate.

6. The circuit structure of claim 5, wherein the adhesive layer comprises an anisotropic conductive film.

7. The circuit structure of claim 1, wherein the display panel substrate is a substrate of the liquid crystal display.

8. The circuit structure of claim 1, wherein the display panel substrate is a TFT substrate and the circuit layers are formed in the TFT substrate.

9. An method for assembling a liquid crystal display module, comprising:
providing a display panel substrate, the display panel substrate comprising a plurality of circuit layers, a bonding area and a plurality of holes, and the holes disposed at the bonding area to electrically connect the circuit layers in the display panel substrate;
adhering an adhesive layer to the bonding area of the display panel substrate and the adhesive layer covering the holes;
attaching a driving circuit to the bonding area of the display panel substrate and the driving circuit covering the holes; and
combining the display panel substrate with a backlight module to form the liquid crystal display module.

10. The method of claim 9, wherein the adhering step comprises adhering an anisotropic conductive film to the bonding area of the display panel substrate and the anisotropic conductive film covering the holes.

11. The method of claim 10, further comprising:
thermo-pressing the driving circuit, the anisotropic conductive film and the display panel substrate.
